(19) United States
(12) Patent Application Publication
(10) Pub. No.: US 2009/0149291 A1
(43) Pub. Date: Jun. 11, 2009

(54) ALL-GEAR FULL TRACTION DIFFERENTIAL GEAR SET

(76) Inventors: Keith E. Gleasman, Fairport, NY (US); James Y. Gleasman, Rochester, NY (US)

Correspondence Address: Woods Oviatt Gilman LLP, 700 Crossroads Bldg, 2 State St., Rochester, NY, 14614, US

(21) Appl. No.: 12/369,942

(22) Filed: Feb. 12, 2009

Related U.S. Application Data
(63) Continuation-in-part of application No. 11/553,603, filed on Oct. 27, 2006.

(51) Int. Cl. F16H 48/10; B23P 11/00

(52) U.S. Cl. 475/227; 29/428

(57) ABSTRACT

A compact, all-gear full-traction differential including meshing pairs of side gears and worm wheel balance gears wherein the numbers of teeth in the spur gear portion and worm wheel portion of each balance gear and in each side gear are all evenly divisible by 2 or by 3, preferably by both 2 and 3. Examples of such a configuration are: spur=12 teeth; worm wheel portion=6 teeth; side gear=12 teeth or spur=18 teeth; worm wheel portion=6 teeth; side gear=12 teeth. The invention is applicable to all cross-axis differential gear assemblies.

### RELATIONSHIP TO OTHER APPLICATIONS AND PATENTS

The present application is a Continuation-In-Part of a pending U.S. patent application Ser. No. 11/553,603, filed Oct. 27, 2006 and published May 1, 2008 as US Patent Application Publication No. 2008/0103008 A1.

### TECHNICAL FIELD

The present invention relates to all-gear full traction differentials of the type commonly referred to as “limited-slip” designed primarily for motor vehicle use; more particularly, to such differentials employing a cross-axis arrangement comprising side gear-on-worm and spur-on-spur gearing; and most particularly, to cross-axis differential arrangements wherein the numbers of teeth in the spur-gear portion and worm-wheel portion of each balance gear and in each side-gear are all evenly divisible by 2 or by 3, preferably by both 2 and 3.

### BACKGROUND OF THE INVENTION

While there are many types of limited-slip differentials, some of the most commercially successful have been the all-gear differentials based upon the designs of Vernon E. Gleasman, and the most efficient of these have been those based upon his crossed-axis design that has been identified commercially as the Torsen®-Type 1 differential. A recent improvement of such known limited-slip differentials using cross-axis planetary gearing is disclosed in U.S. Pat. No. 6,783,476 (“Compact Full-Traction Differential”, assigned to the same assignee as the present invention and identified by the trademark “IsoTorque®”), incorporated by reference herein. The improved differential disclosed in the just-identified patent is smaller in both size and weight than earlier designs of other prior art crossed-axis differentials, and it is less costly to manufacture, while meeting similar load-carrying specifications.

All traditional Gleasman cross-axis differentials (referred herein as “cross-axis” differentials) include pairs of unusual “balance” (combination) gears, e.g., 131, 132 and 131a, 132a in FIGS. 1A and 1B, that (a) mesh with each other through spur-gear portions 133 formed at each end and (b) mesh with the side-gears 141, 142 through helical teeth formed in worm-wheel portions 134 positioned between the two spur teeth ends. A key feature of Gleasman all gear cross-axis differentials, including the older designs (e.g., Torsen®-Type 1), is the relationship of each side gear (hereinafter generally referred to as “side gear worms”), intended to act as a “worm”, with “worm-wheel” teeth on the central portions of each of the differential's balance gears.

A “worm” is traditionally a cylindrical gear with teeth in the form of a screw thread that mates with a larger gear generally identified as a “wormgear” or as a “worm-wheel”, and that latter term is used herein. However, as used in Gleasman-type cross-axis differentials, the side-gear worm is the larger of the two gears. In traditional worm/worm-wheel gearing, there is a mechanical advantage as energy is transferred from the worm to the worm-wheel and a concomitant mechanical disadvantage when energy is transferred from the worm-wheel to the worm. This same mechanical advantage/disadvantage relationship is also true in regard to the transfer of energy between the side-gear worm and the balance gear worm-wheel of the Gleasman-type differentials, as just discussed above.

In vehicles equipped with conventional differentials, when one drive wheel of the vehicle loses traction, most of the engine torque is immediately delivered to the slipping wheel. With Gleasman-type differentials, the mechanical disadvantage created by the worm-wheel/side gear worm connection from the engine to the wheel constrains the excess slipping of the low-traction wheel. This same connection, when operating in the side gear worm/worm-wheel direction, enhances the response of the differential to the changes in drive wheel speeds when the vehicle is turning corners and the outside wheels are traveling over a longer distance than the inside wheels within the same time period.

The geometric requirements for a smooth rolling gear-mesh normally restrict the tooth ratios (i.e., ratio of the number of teeth in one member of a gear pair to the number of teeth in the other member) of true worm/worm-wheel gear sets to a ratio of at least 3.5:1, and much higher tooth ratios are normally designed for this class of gear set. This ratio limitation is true for straight flank worms of the screw thread type as well as for involute helicoid worms of the generated type. Numerous geometric interferences will normally result from any attempt to design worm/worm-wheel gear sets with a ratio lower than 3.5:1.

However, in view of the relatively small package size and relatively high strength requirements of the gear members in a cross-axis differential, the optimal worm/worm-wheel ratio would ideally fall into the gear ratio range of 1.5:1 and 2.5:1, but none of the prior art gears is able to meet these ratios. Therefore, in actual practice, the side gear worm teeth and the balance gear worm-wheel teeth of prior art cross-axis differentials have not been executed as actual worm/worm wheel designs, but rather as crossed helical gear sets, with both elements having simple helical gear geometry. The serious limitation of this approach is that crossed helical gear sets have instantaneous “point” contact, rather than broad area contact patterns, and thus are susceptible to loading limitations and accelerated wear.

The crossed helical gear geometries in the existing art are also quite limited in their frictional component, as they operate primarily in rolling contact over their very limited contact area. Because the effectiveness of torque transfer to the wheel with greater traction depends upon this frictional component, it would be desirable to increase friction in this critical side gear worm/balance gear mesh. Such frictional increases would have little effect upon overall driveline efficiency, since the low relative rotational speed of this set represents only differentiation in wheel speed, normally falling in practice in the 0-20 rpm range.

A partial change from the traditional helical shape is disclosed in above-identified U.S. Pat. No. 6,783,476. That patent discloses a cross-axis differential having helical worm gear/worm-wheel teeth with a “supra-enveloping” contact pattern. Namely, the worm-wheel portions of the balance gears still have the traditional helical-gear shape (an involute helicoid form being cut with a conventional straight-sided hob), while the meshing side gear worms have mating “inverse-involute” teeth that are cut with an involute hob. That patent, as well as other prior art, also suggests the use of “closed-end” side gears.

Conventional crossed-axis helical gears are cut by a hob with straight-sided teeth, the hob being rotated with a combination of plunge and axial feed. Conventional worm-wheels are also cut by a hob with straight-sided teeth, but the hob is rotated with only a plunge-feed and no axial feed.

As indicated above, prior art Gleasman-type cross-axis differentials include unusual balance gears that (a) mesh with each other through spur teeth formed at each end and (b) mesh with the side gear worms through helical teeth formed between the two spur teeth ends. During assembly, these unusual teeth must be positioned in proper mesh and orientation to assure nearly-equal load sharing. This orientation process is referred to as “timing”.

In all prior art cross-axis designs, whether the side gear worm is of the type used in a Torsen®-Type 1 differential, an IsoTorque® differential, or any other side gear worm or worm-wheel design derivative, the gears have a mixture of odd and even numbers of teeth. A typical prior art example is as follows: the number of spur teeth at each end of the balancing gears is 18, the number of teeth in the worm-wheel of each balancing gear is 7, and the number of teeth in each side gear worm is 13. These unusual prior art tooth numbers are not created haphazardly but rather are particularly chosen as perceived allies in combating special gear set wear problems associated with the point or line contact characteristics of crossed helical gear sets. These differing gear numbers create complicated timing problems. For instance, all prior art designs require that timing marks be placed on each combination gear and that careful attention be made during assembly to an instruction chart. The order of gear assembly is indicated as well as the individually different distances that the mark must be rotated for each gear as it is assembled, etc. The prior art instructions, for example, “. . . [T]he internal loads will not be evenly balanced among the gears, and some will be severely overloaded. This will lead to eventual failure, often catastrophic”, warn that incorrect timing can have dangerous results.

It has been found that even when such prior art cross-axis differentials are assembled correctly as designed, the odd numbers of gear teeth, rather than distributing wear and minimizing wear patterns, actually impose an uneven preload on the gears when assembled and create a small but devastating residual meshing error which is passed progressively through the gear sets, creating extremely high point contact loads that result in rapid wear of the helical gears and place the balance gears and their connections to the housing under cyclic stress when the differential is in use.

What is needed in the art is a full traction cross-axis differential, wherein the internal loads are evenly balanced among the gears at all times, and wherein correct alignment and gear timing may be achieved for any improperly positioned balance gear that does not align properly with its respective mounting hole in the housing by merely rotating such a misaligned balance gear by one spur tooth in either direction.

It is a principal object of the present invention to reduce wear and noise in, and to extend the working lifetime of, a full traction cross-axis differential.

It is also an object of the present invention to simplify the assembly procedure of a full traction cross-axis differential.

### SUMMARY OF THE INVENTION

Briefly described, a compact, all-gear full-traction cross-axis differential in accordance with the present invention includes meshing pairs of side-gear worms and worm-wheel balance gears wherein the numbers of teeth in the (a) spur-gear portion and (b) worm-wheel portion of each balance gear, and (c) in each side-gear worm are all divisible by 2 or by 3, preferably by both 2 and 3. The gear teeth of the cross-axis differential, in accordance with the invention, may, but not necessarily, have a “hybrid” design that results in an improved tooth contact pattern between the side gears and the central portion of the balance gears and more closely approximates true worm/worm-wheel characteristics, inherently increasing the effectiveness of torque transfer to the wheel with greater traction, and increasing shock resistance. In such a hybrid tooth design, the teeth of each side-gear have an involute profile but are cut with only plunge feed, while the teeth of the worm-wheel portions of the balance gears are helicoid worms having tip and root modifications made by a concave-shaped cutter. The side-gear teeth have a helix angle equal to or greater than 45° and significantly chamfered ends.

Because the numbers of teeth in the spur, worm-wheel and worm gears are all divisible by 2 or by 3, preferably by both 2 and 3, in accordance with the invention, any improperly positioned balance gear that does not align properly with its respective mounting hole in the housing may be correctly positioned by merely rotating such a misaligned balance gear by one spur tooth in either direction. Importantly, since the internal loads are evenly balanced among the assembled balance gear sets, such an improved differential substantially increases the running lifetime of the gears over that of an otherwise comparable prior art cross-axis differential, even under extreme loading conditions.

### BRIEF DESCRIPTION OF THE DRAWINGS

The present invention will now be described, by way of example, with reference to the accompanying drawings, in which:

FIG. 1A is a schematic and partially cross sectional view of a prior art compact full-traction differential of the type being improved herein;

FIG. 1B is a schematic and partially cross sectional view of the differential of FIG. 1A, the view in FIG. 1B being taken in the plane 1B-1B of FIG. 1A;

FIG. 2 is a schematic and partially cross sectional view similar to that shown in FIG. 1A, but rotated 90°, showing a two-set differential according to the invention with some parts and some cross-hatching removed for clarity;

FIG. 3 is a schematic and partially cross sectional view similar to that shown in FIG. 1B, showing a three-set differential according to the invention, again with some parts and some cross-hatching removed for clarity;

FIG. 4 is a partially schematic representation showing the teeth on the worm-wheel portion of a balance gear being cut by a modified hob tool;

FIG. 5 is a schematic view of greatly enlarged portions of the worm-wheel teeth and the modified hob tool shown in FIG. 4;

FIG. 6 is a partially schematic representation showing the teeth of a side-gear worm being cut by a conventional hob tool in the manner conventionally used to cut worm-wheel teeth; and

FIG. 7 is perspective view of a balance gear and side gear according to the invention.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

In the cross-axis differential in accordance with the invention, the numbers of teeth in the (a) spur-gear portion and (b) worm-wheel portion of each balance gear, and (c) in each side-gear worm are all divisible by 2 or by 3, preferably by both 2 and 3. During assembly, any balance gear that is improperly positioned does not align properly with its respective mounting hole in the housing. As a result of this invention, merely by rotating such a misaligned balance gear by one spur tooth in either direction, correct alignment and gear timing is achieved.

The tooth design, as disclosed in parent US Patent Application Publication No. US 2008/0103008 (hereinafter, the “parent application”), is described as a “hybrid” between standard worm/worm-wheel gearing and helical gearing that produces a “box-like” broad tooth contact pattern (i.e., different than either point or line contact). The new side-gear worm (referred herein as a “hybrid” design) is no longer cut like a conventional cross-axis helical gear. Instead, it is cut in the same manner as a conventional worm-wheel, namely, with only plunge feed and no axial feed. Further, the side-gear worm is provided with a radical helix angle greater than 45° so that it functions effectively as a worm in its relationship with the balance-gear worm-wheel. Compared to the prior art's crossed helical gear sets, the hybrid side gear worm/worm-wheel set of the parent application has the advantages of a significantly broader and longer tooth contact pattern that reduces the unit loading on specific portions of the meshing teeth. Since the side-gear worm has a true hourglass (plunge generated) geometry, the tooth beam sections at both ends of these new side-gear teeth are also thicker and more robust than in the prior crossed helical side gear designs.

Worm/worm-wheel sets, by their nature, have a significantly higher sliding component in their meshing action than helical sets, and this corresponds to a higher frictional component in the mesh. A true worm/worm-wheel set provides a greater mechanical disadvantage when the balance gear worm-wheel tries to back-drive the side-gear worm. Thus, with a true worm/worm-wheel set, the effectiveness of the crossed-axis differential in transferring torque to the wheel with greater traction would be inherently greater than the prior art that is typically based upon crossed helical gear meshes.

In contrast to the prior art, the worm-wheel central portion of each balance gear of the parent application is cut in the same manner as a conventional helical gear, i.e., with axial feed and rotation. However, as part of the hybrid design, the conventional straight-sided hob tool traditionally used to cut helical gear teeth is modified to a slightly “concave” form so that the resulting profile of each worm-wheel tooth becomes an intentional modification of the conventional involute shape to avoid tip and root interferences, so that it can function effectively as a worm-wheel in the unusually low gear ratio of the worm/worm-wheel set.

As mentioned above, conventional worm/worm-wheel design requires that tooth ratios must be at least 3.5:1, while the designs in prior art Gleasman-type differentials have been less than 1:5:1. In a further major deviation from those known designs, the side-gear worm and balance-gear worm-wheel members of each hybrid pair, as disclosed in the parent application, have tooth ratios only between 1.5:1 to 2.5:1.

The hybrid side gear worm/worm-wheel design, as disclosed in the parent application, results in significant improvements in load carrying properties and torque-transfer effectiveness in both two-gear set and three-gear set differentials. The broad and relatively long tooth contact pattern provides smooth operation with superior shock-resisting characteristics.

The hybrid side gear worm/worm-wheel design, as disclosed in the parent application, provides a higher sliding component in mesh, averaged over a larger contact area, than prior art crossed helical sets which primarily have rolling contact over a very limited area. Thus, the hybrid gear set fundamentally increases the effectiveness of torque transfer to the wheel with greater traction. For any given helix angle combination between balance and side gears, back-driving of the side gear by the balance gear becomes more difficult in proportion to increases in this frictional component. This increase in gear mesh friction has very little effect, however, upon driveline efficiency due to the very low typical rotational speeds of the side gear/balance gear set, equal only to the differential rotational speed of the driven wheels. Likewise, there is no increase in gear set wear, not only because of the low speed operation but also because wear is averaged out over a much larger contact area between these members.

Further, the ratios between gears in the differential as a whole, in accordance with the invention, have been rationalized to provide very significant assembly advantages. The odd ratios in prior art designs were chosen in part to combat perceived gear set wear problems associated with the point or line contact characteristics of crossed helical gear sets. The invention's simplification of related gear ratios overcomes the above-mentioned “timing” problems that have plagued prior art differentials in relation to correctly orienting the individual gears during assembly. The invention's interrelated gears are simply and quickly assembled to mesh properly and share the load evenly under all conditions.

In one aspect of the invention, the number of teeth in each set of spur teeth at each end is exactly twice the number of teeth in the central portion of the balance gear. Therefore, without requiring any timing marks on the gears, an incorrect orientation between the side gear and the balance gear will cause the balance gear to become visibly mismatched with the mounting bore for the balance gear in the housing, and rotating the balance gear by one spur tooth in either direction results in correct assembly in every case.

In another aspect of the invention, the side gears have the same number of teeth as the spur-gear portions of the balancing gears (e.g., spur=12; worm-wheel=6; and side-gear worm=12). Since all ratios are divisible by both 2 and 3, the correction of assembly by the rotation of a spur by one tooth, as just explained above, works as described with differentials having either two or three sets of balancing gears. As an alternate arrangement, still being divisible by 2 and 3, the gear teeth numbers can be arranged as spur=18; worm-wheel=6; and side gear worm=12.

This remarkable simplification in timing may be appreciated by comparison with the above-mentioned prior art gear-tooth numbers (e.g., spur=18; worm-wheel=7; and side-gear worm=13) wherein there is only one correct assembly orientation of all the gears among several hundred possible assembly combinations.

Finally, using even numbers of teeth in all of the gears makes it possible to assemble any balance gear in any order into either two- or three-set differentials.

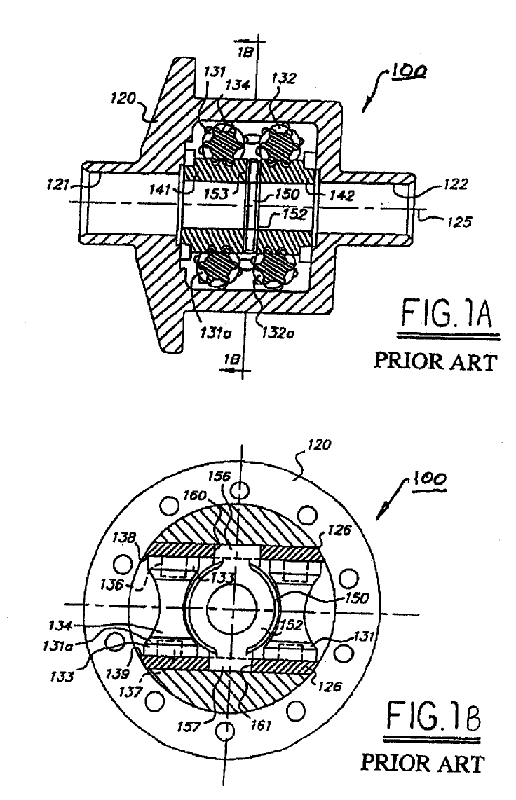

The invention herein improves on the prior art compact full-traction differential disclosed in U.S. Pat. No. 6,783,476 and has a similar basic format of that prior art differential. Therefore, reference is first made to FIGS. 1A and 1B that show two views of a complete prior art side gear worm/worm-wheel gear complex of one embodiment of a prior art differential 100 using only two sets of balance gears.

A housing 120 is preferably made of formed or cast metal and has only three openings, namely, a first set of appropriate openings 121, 122 is aligned along a first axis 125 for receiving the respective inner ends of output axles (not shown); and only a single further opening 126, which is rectangular in shape and extends directly through housing 120, is centered perpendicular to axis 125, creating two openings also known in the art as “windows” for receiving pairs of combination gears.

Two pairs of combination gears 131, 132 and 131a, 132a each have respective spur-gear portions 133 separated by an hourglass-shaped worm-wheel portion 134. The respective spur-gear portions 133 of each pair are in mesh with each other, and all of these combination gears are rotatably supported on sets of paired hubs 136, 137 that are formed integrally with an opposing pair of mounting plates 138, 139. The respective worm-wheel portions 134 of combination gear pair 131, 132 are in mesh with respective ones of a pair of side-gear worms 141, 142, while the respective worm-wheel portions 134 of combination gear pair 131a, 132a are similarly in mesh with, respectively, the same pair of side-gear worms 141, 142.

Positioned intermediate the inner ends of side-gear worms 141, 142 is a thrust plate 150 that includes respective bearing surfaces 152, 153, mounting tabs 156, 157, and a weight-saving lubrication opening. Mounting tabs 156, 157 are designed to mate with slots 160, 161 formed centrally in identical mounting plates 138, 139. Slots 160, 161 not only position thrust plate 150 intermediate the inner ends of side-gear worms 141, 142 but also prevent lateral movement of thrust plate 150. Therefore, and referring now specifically to FIG. 1A, when driving torque applied to side-gear worms 141, 142 results in thrust to the left, side gear worm 142 moves against fixed bearing surface 152 of thrust plate 150, while side gear worm 141 moves away from fixed bearing surface 153 of thrust plate 150 and against housing 120 (or against appropriate washers positioned conventionally between worm 141 and housing 120). The resulting friction against the rotation of side gear worm 141 is unaffected by the thrust forces acting on worm 142. Similarly, when driving torque applied to side-gear worms 141, 142 results in thrust to the right, side gear worm 141 moves against fixed bearing surface 153 of thrust plate 150, while side gear worm, 142 moves away from fixed bearing surface 152 of thrust plate 150 and against housing 120 (or, again, against appropriate washers positioned conventionally between side gear worm 142 and housing 120). Similarly, the resulting friction against the rotation of side gear worm 142 is unaffected by the thrust forces acting on side gear worm 141. Thus, regardless of the direction of the driving torque, the friction acting against the rotation of each side-gear worm is not affected by the thrust forces acting on the other side-gear worm. Since the torque bias of the differential is affected by frictional forces, this prevention of additive thrust forces helps to minimize torque imbalance, i.e., differences in torque during different directions of vehicle turning.

### Basic Structure

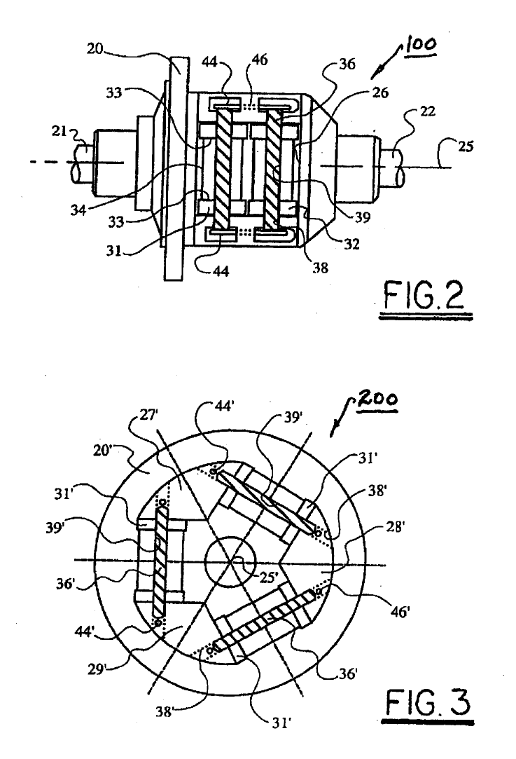

FIG. 2 shows a compact full-traction differential 100 as disclosed in the parent application. However, the view has been rotated about axis 25 by 90°. The housing 20 is similarly fashioned, preferably of formed or cast metal, and has only three openings. Namely, a first set of appropriate openings is aligned along axis 25 for receiving the respective inner ends of output axles 21 and 22. Only a single further opening 26, which is rectangular in shape and extends directly through housing 20, is centered perpendicular to axis 25.

Two pairs of balance gears 31, 32 (only one pair is shown in this view) each have respective spur-gear portions 33 separated by a worm-wheel portion 34. It will be noted that, with the new hybrid gearing design disclosed in the parent application, this central portion of each balance gear does not have the hourglass shape of earlier prior art. While the respective spur-gear portions 33 of each pair are in mesh with each other, the mounting plates of the prior art have been replaced by through holes 38 formed in housing 20, and each balance gear is rotatably supported on a respective journal pin 36 that fits through an appropriate respective mounting through-hole 39 centered axially through each balance gear. Following initial assembly, respective stop pins 44 are press fitted into respective stop pin holes 46 also formed in housing 20 perpendicular to respective through holes 38 to maintain the position of journal pins 36 of each respective pair of balance gears 31, 32.

FIG. 3 shows a three-gear set embodiment 200 of another differential as disclosed in the parent application, this schematic and cross sectional view being taken perpendicular to axis 25′. As persons skilled in the art will understand, such three-gear set differentials may be used to carry the exceptional torque requirements of high performance vehicles. This embodiment includes three pairs of balance gears, but only one balance gear 31′ of each set can be seen in this view. A housing 20′ comprises three opposed mounting sections 27′, 28′, 29′, each mounting section being shaped as a segment with two interior surfaces forming mounting surfaces meeting at 120° and each including a mounting through hole 38′. For providing rotatable support for each balance gear 31′, a plurality of journal pins 36′ are matingly received respectively in the journal holes 39′ formed through each balance gear 31′, and each respective journal pin 36′ is, in turn, received in a respective set of aligned through holes 38′ formed in the opposed mounting surfaces of a respective pair of mounting sections 27′, 28′, 29′ of housing 20′.

Similar to the design of the differential shown in FIG. 2, a plurality of stop pins 44′ can preferably be used to prevent accidental removal of any respective journal pin 36′. Respective stop pins 44′ are press-fitted into respective appropriately sized stop pin holes 46′ formed in respective mounting sections 27′, 28′, 29′ perpendicular to each respective through hole 38′.

### Hybrid Gearing

A feature of the invention disclosed in the parent application is the design of the gearing shared by the side-gear worms and the worm-wheel portions of each of the balance gears. As indicated above, prior art full-traction cross-axis gear differentials have used the traditional involute helicoid tooth designs of cylindrical helical gears for the teeth of both the side-gear worms and the teeth of the worm-wheel portions of the balance gears. In the parent application, the design of both of these gears is modified to provide hybrid gearing that more closely approximates the characteristics of a traditional worm/worm-wheel combination while providing a “box-like” broad tooth contact pattern (i.e., different than either point or line contact of prior art designs). These hybrid teeth characteristics are preferably applied to the respective gears of each pair in the manner explained below.

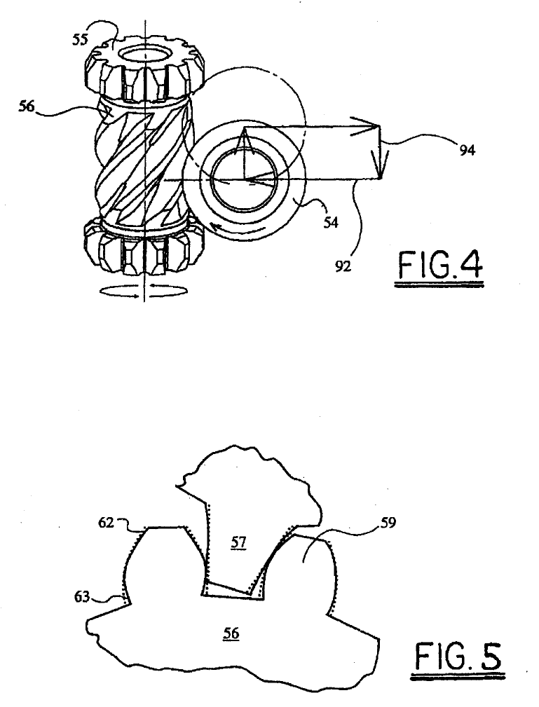

With regard to the modification of the teeth of the worm-wheel portion of the balance gears, FIG. 4 shows the relative motion of a hob 54 during the cutting of the teeth of the worm-wheel portion 56 of a balance gear 55. The initial movement of hob 54 is a plunge feed (PF) 92 to depth followed by an axial feed (AF) 94, relative to balance gear 55, while both the hob and gear rotate. Those skilled in the art will appreciate that this is the same process used to cut a conventional helical gear. However, with the traditional process, the hob cutting tool is straight sided, and the resulting helicoidal teeth have an involute profile.

The traditional process is modified, in accordance with the parent application, by altering the shape of the hob cutter. This is illustrated schematically in FIG. 5 which shows an enlarged cutting tool 57 of hob 54 and two enlarged hybrid teeth 58 and 59 of worm-wheel portion 56 of balance gear 55. Hob cutting tool 57 is not straight sided (as shown in dotted lines) but rather has a slightly concave shape as shown in solid lines. This concave-shaped cutter alters the involute shape of teeth 58, 59 (as shown exaggeratedly in dotted lines) to increase the depth of the cut at both the tip 62 and the root 63 of each tooth as shown in solid lines.

As indicated above, in the optional hybrid gearing design, the design of the side-gear worm is also modified. The new side-gear worm is no longer cut like a conventional cross-axis helical. Instead, it is cut in the same manner as a conventional worm-wheel, namely, in the manner shown schematically in FIG. 6. The teeth 66 of side-gear worm 65 are cut by a conventional involute helicoid hob 67 that has conventional straight-sided cutting tools. However, instead of the traditional plunge and axial feed (e.g., as indicated in FIG. 4) that is normally used for cutting cylindrical helical teeth, hob 67 is only plunge fed (PF) 92 to depth as both side-gear worm 65 and hob 67 rotate. As noted above, teeth 66 are provided with a radical helix angle (i.e., greater than 45°) and the side gear blank is provided with a significant chamfer prior to the hobbing process so that the side-gear teeth are not cut with “closed” ends. A chamfer, as defined herein, is a flat surface made by cutting off the edge of the side-gear worm. A significant chamfer, as used herein, is a chamfer having a width of at least 5% of the radius of the side-gear worm to differentiate from a conventional chamfer merely used in manufacture to flatten excessively sharp edges. Preferably, the significant chamfer has a width of at least 10% of the radius of the side-gear worm.

Although, preferably, in the hybrid design, the side-gear teeth have an involute profile created with only plunge feed and the worm-wheel teeth are preferably helicoid worms having tip and root modifications made by the concave-shaped cutter, as just explained above, in an alternative embodiment: the worm-wheel teeth may have an involute profile created with only plunge feed while the worm-wheel teeth are helicoid worms having tip and root modifications made by a similarly shaped concave-shaped cutter.

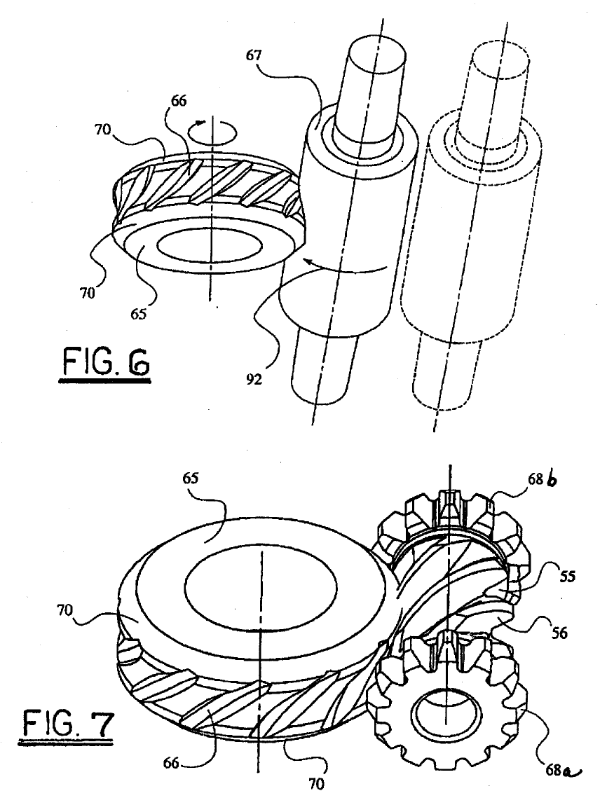

The just-described modifications create the form for side-gear worm 65 and balance gear 55 shown in FIG. 7. As can be seen best in this final view, the chamfering of side-gear worm 65 provides the teeth of side-gear worm 65 with a significant chamfer 70 that improves operation by preventing pinching between the teeth of the gear pair. This improved pair of gears functions with characteristics more closely approximating a true worm/worm-wheel pair, including a sliding component in their meshing action that is significantly higher in comparison to conventional helical sets. This increased sliding component results in a higher frictional component in the mesh. As indicated above, such an increased frictional component increases the mechanical disadvantage that results when the balance gear worm-wheel tries to back-drive the side-gear worm, thereby increasing the effectiveness of the invention's crossed axis differential in transferring torque to the wheel having greater traction.

Also, the gears as shown in FIG. 7 mesh with a broader “box-like” contact pattern over a broader side-gear tooth face, and tip and root interferences are avoided so that each pair can function effectively as a worm/worm-wheel combination with their unusually low 1.5:1-2.5:1 gear ratio. All of these advantages are achieved with the new side gear worm/worm-wheel set of the parent application without any loss in efficiency.

### Timing of Gearing

This new design disclosed in the parent application brings another important advantage. The gear design assures that more than one tooth is in mesh in each gear set at all times, and all gear sets are always in mesh. In the currently preferred design illustrated in FIG. 7, in accordance with the invention, the spur gear sets 68a, b of each balance gear each have twelve (12) teeth, while the worm-wheel portion 56 has only six (6) teeth that mesh with twelve (12) teeth 66 of the side-gear worm 65.

Since these tooth numbers are all divisible by either 2 or 3, all teeth equally share the load at all times. Also, it is impossible to assemble the gears with incorrect timing. That is, any improperly positioned balance gear will not align properly with its respective mounting hole 38, 38′ in its respective housing 20, 20′. Further, by merely rotating such a misaligned balance gear by one spur tooth in either direction, correct alignment and gear timing is achieved, permitting insertion of journal pins 44. In addition, since the tooth numbers are all divisible by either 2 or 3, there are no pre-loads placed on the balance gears during assembly and the internal loads on the gears are balanced thereby increasing the running lifetime of the differential.

Also, with the preferred 12-6-12 design of FIG. 7, any balance gear may be used in any mesh in any two-gear set in a differential such as the design shown in FIG. 2, or the same balance gear can be used in any mesh in a three-gear set performance vehicle differential such as the design shown in FIG. 3. This important feature assures a significant reduction in the time, difficulty, and cost of assembly as well as in the stocking of part inventories. Note that a tooth count design of 18 (spur)-6 (worm wheel)-12 (side gear worm) also meets the “divisible-by-2-and/or-3” criterion and is also contemplated by this invention.

In another aspect of the invention, the teeth of one spur gear portion 68a may be formed to be in axial alignment with the teeth of the other spur gear portion 68b of the same balance wheel 55, as shown in FIG. 7.

With a gear assembly having gear teeth divisible by 2 and/or 3, in accordance with the invention, a simplified method of assembling the gears into housing 20 is as follows:

1) after positioning both side gears into housing 20, install the first balance gear of the first pair of balance gears in a respective opening in said housing in meshing engagement with one of the side gears;

2) determining whether the second balance gear of the first pair of balance gears can be entered into the respective opening in first meshing contact with said first balance gear and also second meshing contact with the other of the side gears;

3) proceeding to such entering of the second balance gear oriented for first and second meshing contact;

4) rotating the second balance gear by no more than one spur gear tooth to achieve said first and second meshing contacts if the second balance gear is not oriented to provide such entering in step 3, and then proceeding to such entering; and

5) repeating steps 1) through 4) for each additional pair of balance gears.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A cross-axis differential gear assembly comprising:
a. a side gear; and
b. a first balance gear having a worm wheel portion and at least one spur gear portion adjacent said worm wheel portion
wherein said worm wheel portion is in mating contact with said side gear and said at least one spur gear portion of said first balance gear is in mating contact with a spur gear portion of a second balance gear; and
wherein the number of teeth of each spur gear portion, the number of teeth of said worm wheel portion and the number of teeth of said side gear are divisible evenly by 2 or by .

2. A cross-axis differential gear assembly in accordance with claim 1 wherein said numbers of said spur gear portion teeth, said worm wheel portion teeth, and said side gear teeth are all divisible evenly by 2 and by 3.

3. A cross-axis differential gear assembly in accordance with claim 1 wherein said side gear is selected from the group consisting of worm and hybrid.

4. A cross-axis differential gear assembly in accordance with claim 1 wherein said side gear is helical.

5. A cross-axis differential gear assembly in accordance with claim 1 further comprising a gear complex including a pair of side gears, at least two sets of first and second balance gears and a housing driven by an external power source wherein power from said external power source is transferred to said pair of side gears, each of said side gears comprising a plurality of side gear teeth, the gear complex comprising the side gears rotating about a first axis, each side gear being fixed to a respective one of two output axles received in the housing, each balance gear of each set being mounted for rotation about an axis substantially perpendicular to the first axis, each balance gear of each set having a pair of spur gear portions comprising a plurality of spur-gear teeth spaced apart from a worm wheel portion having a plurality of worm wheel teeth, each first balance gear of each set being in mating engagement with the second balance gear of the same set through the spur gear portions and in mating engagement with a respective one of the side gears through the worm wheel portion.

6. A cross-axis differential gear assembly in accordance with claim 3 wherein said side gear teeth have an involute profile with only plunge feed and said worm wheel portion teeth are helicoid worms having tip and root modifications.

6. A cross-axis differential gear assembly in accordance with claim 3 wherein said worm wheel portion teeth have an involute profile with only plunge feed and said side gear teeth are helicoid worms having tip and root modifications.

7. A cross-axis differential gear assembly in accordance with claim 1 wherein the number of said spur gear portion teeth is twice the number of said worm wheel portion teeth of the same balance gear.

8. A cross-axis differential gear assembly in accordance with claim 1 wherein each spur gear portion has twelve spur gear portion teeth, each worm wheel portion has six worm wheel portion teeth, and each side gear has twelve side gear teeth.

9. A cross-axis differential gear assembly in accordance with claim 1 wherein each spur gear portion has eighteen spur gear portion teeth, each worm wheel portion has six worm wheel portion teeth, and each side gear has twelve side gear teeth.

10. A cross-axis differential gear assembly in accordance with claim 1 wherein said first balance gear includes a first spur gear portion, and a second spur gear portion at an opposite end of said worm wheel portion said spur gear portion teeth of said first and second spur gear portions are axially aligned.

11. A method for assembling a cross-axis differential gear assembly for transferring rotational forces from an external power source to a pair of side gears in a gear complex supported in a housing rotationally driven by the external power source, each side gear comprising a plurality of side gear teeth, the gear complex comprising the side gears rotating about a first axis, each side gear being fixed to a respective one of two output axles received in the housing, at least two sets of paired balance gears, each balance gear of each set being mounted for rotation about an axis substantially perpendicular to the first axis, each balance gear having a pair of spur gear portions comprising a plurality of spur gear teeth spaced apart from a worm wheel portion comprising a plurality of worm wheel teeth, each balance gear being in mating engagement with the other balance gear of the pair through the spur gear portions and in mating engagement with a respective one of the side gears through the worm-wheel portion, wherein, after positioning both side gears into the housing, the method comprising the steps of:
1) installing a first balance gear of a first pair of balance gears in a respective opening in said housing in meshing engagement with one of the side gears;
2) determining whether a second balance gear of said first pair of balance gears can be entered into the respective opening in first meshing contact with said first balance gear and also second meshing contact with the other of said side gears;
3) proceeding to such entering of said second balance gear oriented for said first and second meshing contact;
4) rotating said second balance gear by no more than one spur gear tooth to achieve said first and second meshing contacts if the second balance gear is not oriented to provide such entering in step 3, and then proceeding to such entering; and
5) repeating steps 1) through 4) for each additional pair of balance gears.

11. A motor vehicle comprising,
a cross-axis differential gear assembly having a side gear and a first balance gear, said first balance gear having a worm wheel portion and at least one spur gear portion adjacent said worm wheel portion
wherein said worm wheel portion is in mating contact with said side gear and said at least one spur gear portion of said first balance gear is in mating contact with a spur gear portion of a second balance gear; and
wherein the number of teeth of each spur gear portion, the number of teeth of said worm wheel portion and the number of teeth of said side gear are divisible evenly by 2 or by 3.

12. A motor vehicle, in accordance with claim 11, wherein the number of teeth of each spur gear portion, the number of teeth of said worm wheel portion and the number of teeth of said side gear are divisible evenly by 2 and by 3.
